(19) United States
(12) Patent Application Publication
(10) Pub. No.: US 2015/0259575 A1
(43) Pub. Date: Sep. 17, 2015

(54) POLISHING COMPOSITION

(71) Applicant: NITTA HAAS INCORPORATED, Osaka (JP)

(72) Inventors: Rika TANAKA, Kyotanabe-shi (JP); Haruki NOJO, Kyotanabe-shi (JP); Yoshiharu OTA, Kyotanabe-shi (JP)

(21) Appl. No.: 14/727,467

(22) Filed: Jun. 1, 2015

Related U.S. Application Data
(63) Continuation of application No. 12/451,932, filed on Feb. 25, 2010, now abandoned.

(30) Foreign Application Priority Data
Jun. 8, 2007 (JP) 2007-153422

(51) Int. Cl. C09G 1/02; C23F 3/06; C23F 3/04

(52) U.S. Cl. CPC C09G 1/02; C23F 3/04; C23F 3/06

(57) ABSTRACT

A polishing composition of the invention is a polishing composition which is suitable for polishing a metal film, which is so-called final polishing, and contains colloidal silica having an average particle size of 20 nm or more and less than 80 nm which is determined by particle size distribution measurement using a light scattering method as abrasive grains; and at least one selected from iodic acid and its salt as an oxidizing agent, with the balance of water. By containing such components, the polishing composition shows nonselectivity, while being sufficiently suppressed in dishing and erosion.

### TECHNICAL FIELD

The present invention relates to a polishing composition used in CMP treatment, particularly used in polishing a metal film.

### BACKGROUND ART

According to a damascene process used in a semiconductor process, for example, on a surface of a substrate which is coated with a silicon dioxide film are formed a groove corresponding to a wiring pattern to be formed and a hole corresponding to a plug (electrical connection part with wiring in a substrate) to be formed, thereafter a barrier metal film (insulating film) comprising titanium or titanium nitride is formed on inner wall surfaces of the groove and the hole, subsequently the entirety of the surface of the substrate is coated with, for example, a tungsten film as a wiring metal by plating or the like, thereby embedding tungsten in the groove and the hole, and a superfluous tungsten film on areas other than the groove and the hole is removed by chemical mechanical polishing (CMP), thus forming a wiring and a plug on the surface of the substrate.

In a flattening process of a metal film such as tungsten, a metal film is greatly removed by primary polishing of high polishing rate, and final polishing is then conducted. Where the same polishing composition (slurry) as in primary polishing is used in the final polishing, a metal film is excessively polished, and dishing and erosion are generated. For this reason, slurry for final polishing is required to use slurry (nonselective slurry) such that selectivity which is a ratio between polishing rate of a metal film and polishing rate of an oxide film is decreased. When the selectivity is small, a metal film and an oxide film are polished in approximately the same polishing rate, resulting in suppression of occurrence of dishing and erosion.

The nonselective slurry includes a polishing composition which contains a given content of colloidal silica, at least one selected from periodical acid and its salt, ammonia and ammonium nitride and which reduces amount of erosion (for example, refer to Japanese Unexamined Patent Publication JP-A 2004-123880).

### DISCLOSURE OF INVENTION

The polishing composition described in JP-A 2004-123880 permits final polishing using at least one selected from periodical acid having high etching performance and its salt, and abrasive grains having a relatively large particle size that an average particle size obtained by a light scattering method is from 80 to 300 nm, in order to polish a barrier metal such as titanium.

However, the polishing composition has the problem that after the removal of the barrier metal, a wiring metal such as tungsten dissolves by at least one etching performance selected from periodical acid and its salt, and progress of dishing and occurrence of erosion due to the progress cannot sufficiently be suppressed.

An object of the invention is to provide a polishing composition having nonselectivity and capable of suppressing occurrence of dishing and erosion.

The invention provides a polishing composition comprising colloidal silica having an average particle size of 20 nm or more and less than 80 nm which is determined by particle size distribution measurement using a light scattering method, and an oxidizing agent having a passive current value of 0 mA or more and 0.5 mA or less.

According to the invention, the polishing composition comprises colloidal silica having an average particle size of 20 nm or more and less than 80 nm which is determined by particle size distribution measurement using a light scattering method, and an oxidizing agent having a passive current value of 0 mA or more and 0.5 mA or less.

When the oxidizing agent having a passive current value of 0 mA or more and 0.5 mA or less and the colloidal silica having a small average particle size defined in the above preferred range are used, polishing rate of the barrier metal can be improved. Furthermore, the polishing rate of the barrier metal and polishing rates of a wiring metal film and an oxide film are approximately the same, and nonselectivity is also realized.

The oxidizing agent having a passive current value of 0 mA or more and 0.5 mA or less does not have etching performance. Therefore, after the removal of the barrier metal, a wiring metal such as tungsten is not etched, and this permits to sufficiently suppress progress of dishing, eventually, occurrence of erosion.

In addition, in the invention, it is preferable that the oxidizing agent comprises at least one selected from chloric acid, bromic acid, iodic acid, persulfuric acid and their salts, and a tetravalent cerium compound.

According to the invention, the oxidizing agent can use at least one selected from chloric acid, bromic acid, iodic acid, persulfuric acid and their salts, and a tetravalent cerium compound.

Further, in the invention, it is preferable that the polishing composition has a pH of 1.0 or more and 2.0 or less.

Furthermore, according to the invention, when the polishing composition has a pH of 1.0 or more and 2.0 or less, a sufficient polishing rate can be realized. Moreover, the polishing composition having a pH of 1.0 or more and 2.0 or less provides a polishing composition having extremely small change in properties over time when comparing with a polishing composition having a pH outside the range.

### BRIEF DESCRIPTION OF DRAWINGS

Other and further objects, features, and advantages of the invention will be more explicit from the following detailed description taken with reference to the drawings wherein:

FIG. 1 is a graph showing the relationship between an average particle size of colloidal silica and polishing rate;

FIG. 2 is a graph showing the relationship between an average particle size of colloidal silica and selectivity;

FIG. 3A is a view showing surface profile of a wafer having a wiring width of 100 μm in the case of using Example 3;

FIG. 3B is a view showing surface profile of a wafer having a wiring width of 100 μm in the case of using Comparative Example 8;

FIG. 4A is a view showing surface profile of a wafer having a wiring width of 10 μm in the case of using Example 3; and

FIG. 4B is a view showing surface profile of a wafer having a wiring width of 10 μm in the case of using Comparative Example 8.

### BEST MODE FOR CARRYING OUT THE INVENTION

Now referring to the drawings, preferred embodiments of the invention will be described in detail.

The polishing composition of the invention is a polishing composition suitable for use in polishing a metal film, that is, final polishing. The polishing composition comprises colloidal silica having an average particle size of 20 nm or more and less than 80 nm which is determined by particle size distribution measurement using a light scattering method as abrasive grains, an oxidizing agent having a passive current value of 0 mA or more and 0.5 mA or less, and the remainder of water. The composition comprising these components can not only realize nonselectivity but also sufficiently suppress dishing and erosion.

The polishing composition of the invention is described in detail below.

Abrasive grains contained in the polishing composition of the invention are preferably colloidal silica having an average particle size of 20 nm or more and less than 80 nm which is determined by particle size distribution measurement using a light scattering method.

Where the average particle size determined by particle size distribution measurement using a light scattering method is smaller than 20 nm, any polishing rate of the barrier metal, a wiring metal and an oxide film is decreased. On the other hand, where the average particle size determined by particle size distribution measurement using a light scattering method is 80 nm or more, any polishing rate of the barrier metal, a wiring metal and an oxide film is decreased, and additionally, a difference in the respective polishing rate is increased, resulting in development of selectivity.

The content of the colloidal silica in the polishing composition of the invention is 3% by weight or more and 40% by weight or less, and preferably 5% by weight or more and 23% by weight or less, based on the total weight of the polishing composition. Where the content of the colloidal silica is less than 5% by weight, polishing rate is decreased, and where the content exceeds 23% by weight, aggregation is easily generated.

The oxidizing agent contained in the polishing composition of the invention is preferably an oxidizing agent having a passive current value of 0 mA or more and 0.5 mA or less.

The “passive current value” used herein is defined as follows.

When a metal reaches a certain voltage in Tafel plot measurement, the surface of the metal is passivated and a current value is rapidly decreased. Even though voltage is subsequently increased, rise in current is not observed. The minimum current value observed in this low level is defined as a passive current value.

The Tafel plot measurement can be made by dipping a work electrode (tungsten electrode), a counter electrode (platinum electrode) and a reference electrode (calomel electrode) in an oxidizing agent solution, and plotting a current value when voltage is changed from −1.0V to 2.0V.

The oxidizing agent having a passive current value of 0 mA or more and 0.5 mA or less does not have etching performance. Therefore, after the removal of the barrier metal, a wiring metal such as tungsten is not etched, and this permits to sufficiently suppress progress of dishing, and eventually, occurrence of erosion.

Examples of the oxidizing agent having a passive current value of 0 mA or more and 0.5 mA or less include at least one selected from chloric acid, bromic acid, iodic acid, persulfuric acid and their salts, and a tetravalent cerium compound. The salt is preferably a potassium salt, a sodium salt or a calcium salt.

The oxidizing agent is particularly preferably at least one selected from iodic acid and its salt. Examples of the salt include potassium iodate (KIO₃), sodium iodate and calcium iodate. Among them, iodic acid and potassium iodate are most preferred.

The content of the oxidizing agent in the polishing composition of the invention is 0.1% by weight or more and 7% by weight or less, and preferably 0.3% by weight or more and 3% by weight or less, based on the total weight of the polishing composition. Where the content of the oxidizing agent is less than 0.1% by weight, polishing rate is decreased. Furthermore, even though the oxidizing agent is added in an amount exceeding 7% by weight, increase in polishing rate is not observed.

The polishing composition of the invention is strongly acidic, and its pH is a range of 1.0 or more and 2.0 or less. When the pH falls within a range of 1.0 or more and 2.0 or less, a polishing composition free of change over time of properties is obtained. Where the pH is less than 1.0, aggregation of abrasive grains is generated with time elapsed from the production. Further, where the pH exceeds 2.0, the polishing composition turns into a gel with time elapsed from the production.

A titanium film as the barrier metal has conventionally been polished by an oxidizing agent having strong etching performance, such as periodical acid, and abrasive grains having a large particle size. However, as stated above, this method had the problem that after the removal of the barrier metal, a wiring metal is dissolved by etching with an oxidizing agent.

Contrary to this, the invention uses an oxidizing agent having a passive current value of 0 mA or more and 0.5 mA or less as an oxidizing agent which does not have etching performance, and combines the oxidizing agent with colloidal silica having small particle size. This combination improves polishing rate of the barrier metal, and realizes a polishing composition which does not cause dissolution of a wiring metal by etching even after the removal of the barrier metal. Furthermore, the combination achieves the same polishing rate even in an oxide film, and further realizes nonselectivity.

The polishing of the barrier metal in the case of using the polishing composition of the invention does not merely mechanically scrape off the barrier metal film weakened by an oxidizing agent with abrasive grains. A silanol group as a surface active group exposed on the surface of colloidal silica acts to the surface of the barrier metal film, thereby the barrier metal film is easily polished and removed.

This reason is considered as follows. By decreasing an average particle size of colloidal silica than the conventional particle size, surface area of colloidal silica is increased, and action by the silanol group is remarkably developed. As a result, polishing rate of the barrier metal is improved.

Further, it is known that in the case of using fumed silica which hardly has the silanol group on the surface thereof, improvement in polishing rate of the barrier metal is not achieved even though an average particle size is decreased. It can be said from this fact that action by the silanol group of colloidal silica facilitates polishing and removal of the barrier metal film.

The polishing composition of the invention may further comprise additives in addition to the above composition.

Examples of the additives include organic acids or inorganic acids which function as a pH adjuster. Specific examples of the additives include nitric acid (HNO₃), sulfuric acid, hydrochloric acid, acetic acid, lactic acid, citric acid, tartaric acid and malonic acid. Among them, nitric acid is particularly preferred.

When nitric acid is added to the polishing composition of the invention, aggregation of colloidal silica is suppressed, and a polishing composition having higher stability can be realized.

The content of the additives is not particularly limited. The additives are added in an appropriate amount such that a polishing composition has a pH of 1.0 or more and 2.0 or less.

The polishing composition of the invention can contain one or more of various additives conventionally used in a polishing composition in this technical field, as other additives in an amount such that preferable properties of the polishing composition are not impaired.

Water used in the polishing composition of the invention is not particularly limited. Considering use in production process of a semiconductor device or the like, pure water, ultrapure water, ion-exchanged water, distilled water or the like is preferably used.

As a method for producing the polishing composition of the invention, the conventional method for producing a polishing composition can be used.

### EXAMPLES

First, a gelation time and a particle growth rate have been investigated on the influence of pH to the polishing composition of the invention.

Investigation Samples 1 to 5 for evaluating the gelation time were prepared with the following composition. The term “Others” includes additives and water.

| | |
|---|---|
| Colloidal silica | 23% by weight |
| Iodic acid | 0.5% by weight |
| Others | Remainder |

Investigation Sample 1 has a pH of 1.5, Investigation Sample 2 has a pH of 2.0, Investigation Sample 3 has a pH of 2.9, Investigation Sample 4 has a pH of 5.2, and Investigation Sample 5 has a pH of 7.1. The pH of Investigation Samples 1 to 5 was adjusted using an appropriate amount of the inorganic acid.

The gelation time was measured using the Investigation Samples 1 to 5. Evaluation method for the gelation time is as follows.

[Gelation Time]

Investigation Samples 1 to 5 were placed in prescribed vessels, respectively, and the vessels were allowed to stand at room temperature (25° C.). After starting the still standing, each vessel was occasionally inclined, and a time elapsed until liquid level did not move was defined as the gelation time.

The measurement results obtained are shown in Table 1 below. The measurement results are shown by relative evaluation on a condition that the gelation time of Investigation Sample 5 is designated as a standard (1.0).

TABLE 1

| | pH | Gelation time |
|---|---|---|
| | [—] | [—] |
| Investigation Sample 1 | 1.5 | 120 |
| Investigation Sample 2 | 2.0 | 12 |
| Investigation Sample 3 | 2.9 | 1.0 |
| Investigation Sample 4 | 5.2 | 0.2 |
| Investigation Sample 5 | 7.1 | 1.0 |

The samples having a pH exceeding 2.0 as Investigation Samples 3 to 5 showed fast progress of gelation as compared with the samples having a pH of 2.0 or less as Investigation Samples 1 and 2, and showed a change in properties over time.

Investigation Samples 6 to 9 for evaluating particle growth rate were prepared with the following composition. The term “Others” includes additives and water.

| | |
|---|---|
| Colloidal silica | 23% by weight |
| Iodic acid | 0.5% by weight |
| Others | Remainder |

Investigation Sample 6 has a pH of 0.7, Investigation Sample 7 has a pH of 1.0, Investigation Sample 8 has a pH of 1.6, and Investigation Sample 9 has a pH of 2.0. The pH of Investigation Samples 6 to 9 was adjusted with an appropriate amount of an inorganic acid.

Particle growth rate was measured using the Investigation Samples 6 to 9. Evaluation method for the particle growth rate is as follows.

[Particle Growth Rate]

Investigation Samples 6 to 9 were placed in given vessels, respectively, and the vessels were allowed to stand in an oven set to a temperature of 60° C. for 3 hours. An average particle size of abrasive grains before still standing and an average particle size of abrasive grains after still standing for three hours were measured, respectively. Particle growth rate was calculated by diving difference in average particle sizes before and after still standing by three hours that is the still standing time. The average particle size was determined by a light scattering method using a particle size distribution measuring apparatus (manufactured by Otsuka Electronics Co., Ltd., Particle-size Analyzer ELS-Z2).

The measurement results obtained are shown in Table 2 below. The measurement results are shown by relative evaluation on a condition that the particle growth rate of Investigation Sample 6 is designated as a standard (1.0).

TABLE 2

| | pH | Particle growth rate |
|---|---|---|
| | [—] | [—] |
| Investigation Sample 6 | 0.7 | 1.0 |
| Investigation Sample 7 | 1.0 | 0.26 |
| Investigation Sample 8 | 1.6 | 0.24 |
| Investigation Sample 9 | 2.0 | 0.32 |

The sample having a pH less than 1.0 as in Investigation Sample 6 had a fast particle growth rate as compared with the samples having a pH of 1.0 or more and 2.0 or less as in Investigation Samples 7 to 9, and showed a change in properties over time.

Examples and Comparative Examples of the invention are described below.

Examples of the invention and Comparative Examples were prepared in the following composition. The term “Others” includes additives and water.

| | |
|---|---|
| Colloidal silica | 12% by weight |
| Potassium iodate | 0.7% by weight |
| Others | Remainder |

In the Examples, an average particle size of colloidal silica was changed, respectively. The average particle size of Example 1 is 27.1 nm, the average particle size of Example 2 is 30.0 nm, the average particle size of Example 3 is 34.8 nm, the average particle size of Example 4 is 49.5 nm, the average particle size of Example 5 is 54.0 nm, the average particle size of Example 6 is 64.3 nm, and the average particle size of Example 7 is 72.1 nm.

Further, in the Comparative Examples, an average particle size of colloidal silica was changed, respectively. The average particle size of Comparative Example 1 is 17.6 nm, the average particle size of Comparative Example 2 is 81.0 nm, the average particle size of Comparative Example 3 is 86.8 nm, the average particle size of Comparative Example 4 is 99.2 nm, and the average particle size of Comparative Example 5 is 133.8 nm.

In both the Examples and the Comparative Examples, a pH was adjusted to 1.75 by adding an adequate amount of a pH adjuster thereto.

Colloidal silica having an average particle size of 20 nm or more and less than 80 nm which is determined by the light scattering method was used in Examples 1 to 7, and colloidal silica having an average particle size falling outside the range which is determined by the light scattering method was used in Comparative Examples 1 to 5.

Polishing rate was measured using the above Examples and Comparative Examples. Polishing conditions, and the evaluation method for a polishing rate are as follows.

[Polishing Conditions]

Substrate to be polished: Tungsten substrate, titanium substrate and plasma TEOS substrate (each having a diameter of 8 inches)

Polishing device: SH24 (manufactured by SpeedFam-IPEC Co., Ltd.)

Polishing pad: IC1400-K-grv. (manufactured by Nitta Haas Incorporated)

Rotation speed of polishing plate: 65 (rpm)

Rotation speed of carrier: 65 (rpm)

Surface pressure of polishing load: 5 (psi)

Flow rate of semiconductor polishing composition: 125 (ml/min)

Polishing time: 60 (sec)

[Polishing Rate]

Polishing rate is expressed by a thickness (A/min) of a wafer removed by polishing per unit time. The thickness of a wafer removed by polishing was calculated by measuring an amount of weight loss of a wafer and dividing the amount by an area of a polishing surface of a wafer.

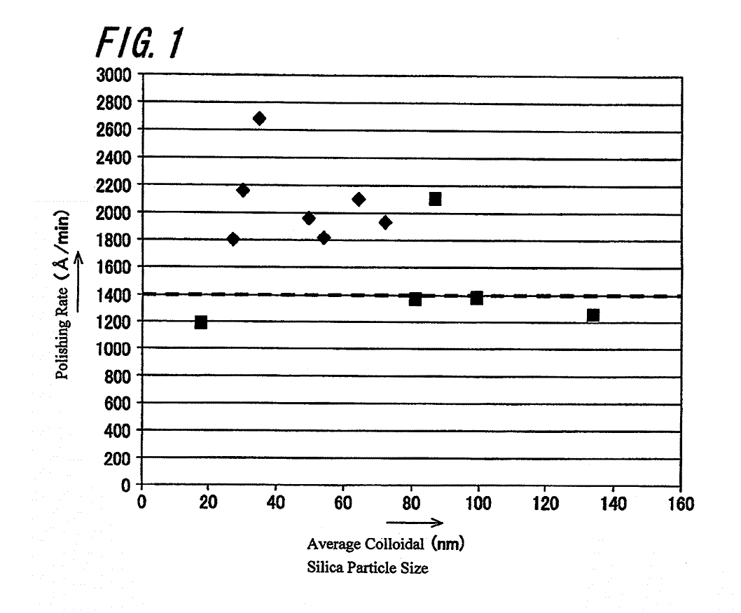

FIG. 1 is a graph showing the relationship between an average particle size of colloidal silica and polishing rate.

In FIG. 1, a horizontal axis shows an average particle size of colloidal silica determined by the light scattering method, and a vertical axis shows polishing rate of tungsten.

An average particle size of colloidal silica was determined by particle size distribution measuring apparatus (manufactured by Otsuka Electronics Co., Ltd., Particle-size Analyzer ELS-Z2) using the light scattering method.

Further, rhombic plot shows polishing rate of the Examples, and square plot shows polishing rate of the Comparative Examples.

As seen from the graph, when the average particle size of colloidal silica is smaller than 20 nm or 80 nm or more, the polishing rate was lower than 1,400 Å/min which is polishing rate required in this technical field. Comparative Example 3 (average particle size=86.8 nm) showed relatively high polishing rate, but the selectivity was smaller than the desired value as described below.

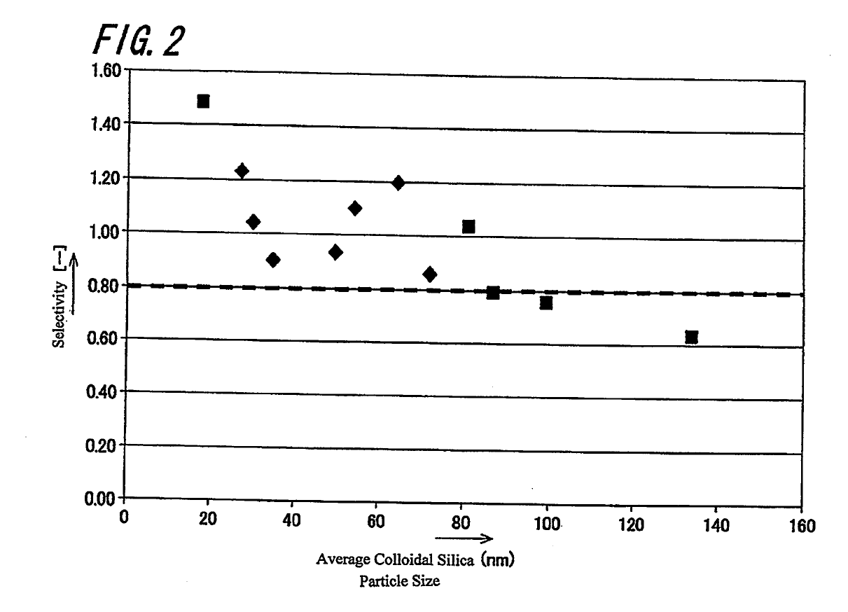

FIG. 2 is a graph showing the relationship between an average particle size of colloidal silica and selectivity.

In FIG. 2, a horizontal axis shows an average particle size of colloidal silica determined by the light scattering method, and a vertical axis shows selectivity which is a ratio between polishing rate of titanium film and polishing rate of TEOS film.

As seen from the graph, when an average particle size of colloidal silica was increased, the selectivity was lower than 0.8 which is selectivity required in this technical field.

Now, etching performance in the Examples and the Comparative Examples was investigated.

### Comparative Example 6

| | |
|---|---|
| Colloidal silica (average particle size = 70 nm) | 12% by weight |
| Hydrogen peroxide | 0.7% by weight |
| Water | Remainder |

### Comparative Example 7

| | |
|---|---|
| Colloidal silica (average particle size = 70 nm) | 12% by weight |
| Orthoperiodic acid | 0.7% by weight |
| Water | Remainder |

### Comparative Example 8

| | | |
|---|---|---|
| Fumed silica | 5% | by weight |
| Hydrogen peroxide | 4% | by weight |
| Iron ion | 50 | ppm |

| | |
|---|---|
| Water | Remainder |

Using Comparative Examples 6 to 8 and Example 3, etching rate and passive current value were measured as follows.

[Etching Rate]

Etching rate was measured as follows. Tungsten (3 cm×4 cm) whose thickness was measured was dipped in a polishing composition having a liquid temperature of 50° C. for one minute. After dipping the plate, the tungsten plate was rinsed with water, and its thickness was measured. Thickness of a wafer removed by dipping for one minute was calculated as polishing rate.

[Passive Current Value]

The passive current value was obtained based on the Tafel plot. Measurement of the Tafel plot is as follows. Tungsten electrode, platinum electrode and calomel electrode were dipped in a polishing composition, and current value, when voltage was changed from −1.0 V to 2.0 V, was plotted.

Example 3 did not show change in thickness before and after dipping. Specifically, etching rate of Example 3 was 0, and passive current value thereof was 0.09 mA. On the other hand, etching rate of Comparative Example 5 was 323 Å/min, and passive current value thereof was 0.51 mA. Etching rate of Comparative Example 6 was 325 Å/min, and passive current value thereof was 0.54 mA. Etching rate of Comparative Example 7 was 515 Å/min, and passive current value thereof was 0.69 mA. Thus, The polishing composition of the invention shows the etching rate of 0, and therefore does not cause dishing and erosion.

The thickness of the tungsten plate was measured using RS35C, manufactured by PROMETRIX.

Comparative Examples 5 to 7 show very high etching rate, and this is the cause inducing dishing and erosion.

Further, in order to confirm an influence of etching performance, a wafer with a metal wiring applied thereto was dipped in the polishing compositions of Example 3 and Comparative Example 5, and a surface profile of a wiring part was measured.

The wafer is in a state after final polishing, that is, in a state after a barrier metal has been removed, and the wiring metal is tungsten. To confirm an influence of wiring width, three kinds of wafers having a wiring width of 100 μm and 10 μm were used.

The wafers were dipped in a polishing composition having a temperature of 50° C. for three minutes, then rinsed and dried. Surface profile of the wafers was measured. The surface profile of the wafers was measured using P-12 (manufactured by KLA-Tencor Corporation).

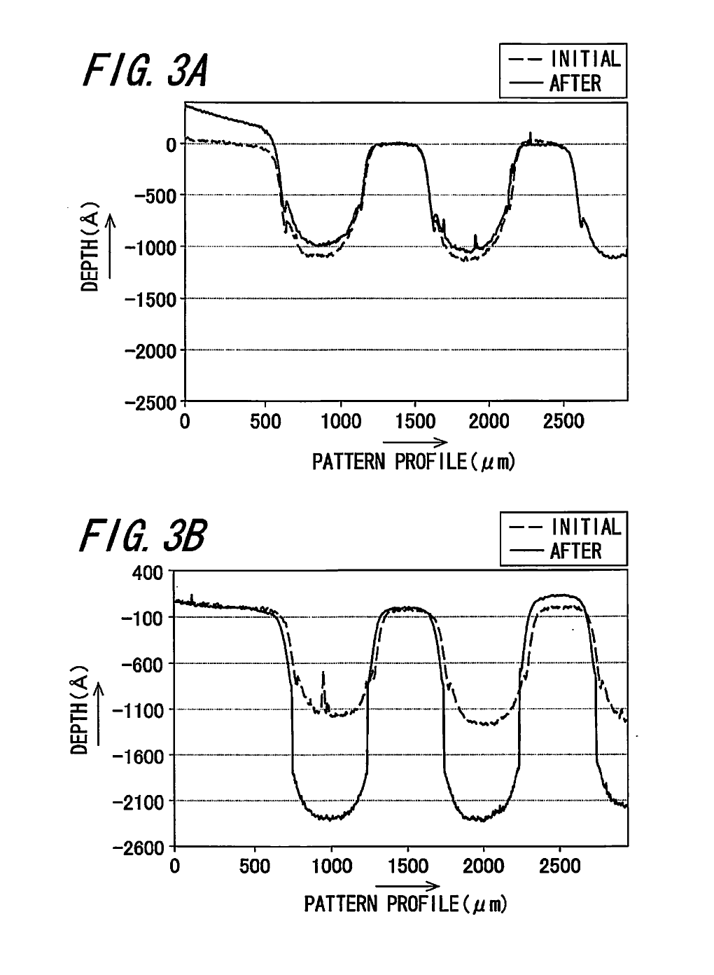

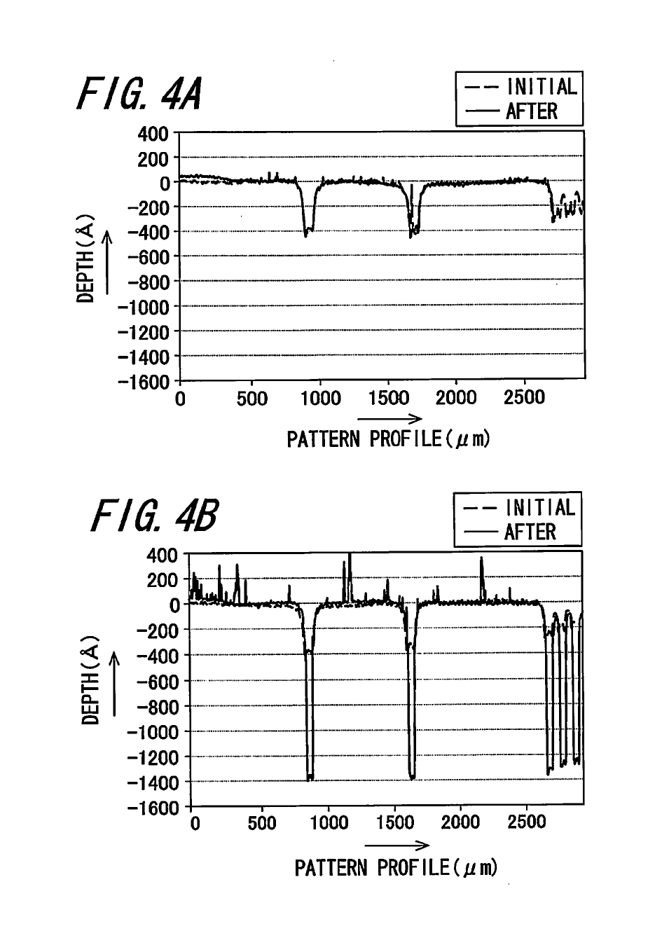

FIG. 3A is a view showing surface profile of a wafer having a wiring width of 100 μm in the case of using Example 3, and FIG. 3B is a view showing surface profile of a wafer having a wiring width of 100 μm in the case of using Comparative Example 8. FIG. 4A is a view showing surface profile of a wafer having a wiring width of 10 μm in the case of using Example 3, and FIG. 4B is a view showing surface profile of a wafer having a wiring width of 10 μm in the case of using Comparative Example 8.

In these graphs, a horizontal axis shows a position, and a vertical axis shows a depth. The profile after dipping is shown in a solid line, and the profile before dipping is shown in a broken line.

It is understood that the wafer dipped in Comparative Example 8 has an increased depth of the wiring part after dipping, thus showing progress of dishing. Whereas, it is understood that the wafer dipped in Example 3 has the same depth of the wiring part before and after dipping, and thus dishing does not proceed at all. Further, the same results as these results were obtained regardless of wiring depth.

From the above description, the polishing composition of the invention not only realizes high polishing rate and nonselectivity but also can suppress dishing and erosion.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1-3. (canceled)

4. A polishing composition for polishing a tungsten film, comprising:
colloidal silica having an average particle size of 20 nm or more and less than 80 nm which is determined by particle size distribution measurement using a light scattering method, and
an oxidizing agent,
the polishing composition having a passive current value of 0 mA or more and 0.5 mA or less, and
the passive current value is defined as the minimum current value observed in a voltage range higher than the voltage at which the current rapidly decreases, based on the surface of the tungsten film being passivated, in a Tafel plot.

5. The polishing composition of claim 4, wherein the oxidizing agent comprises at least one selected from chloric acid, bromic acid, iodic acid, persulfuric acid and their salts, and a tetravalent cerium compound.

6. The polishing composition of claim 5, wherein the polishing composition has a pH of 1.0 or more and 2.0 or less.

7. The polishing composition of claim 5, wherein the oxidizing agent comprises at least one selected from chloric acid, bromic acid, iodic acid, persulfuric acid, potassium iodate, sodium iodate, calcium iodate, and a tetravalent cerium compound.

8. A polishing composition for polishing a tungsten film, comprising:
colloidal silica having an average particle size of 20 nm or more and less than 80 nm which is determined by particle size distribution measurement using a light scattering method, and
an oxidizing agent including at least two selected from chloric acid, bromic acid, iodic acid, persulfuric acid and their salts, and a tetravalent cerium compound,
the polishing composition having a passive current value of 0 mA or more and 0.5 mA or less, and
the passive current value is defined as the minimum current value observed in a voltage range higher than the voltage at which the current rapidly decreases, based on the surface of the tungsten film being passivated, in a Tafel plot.

9. The polishing composition of claim 8, wherein the oxidizing agent comprises at least two selected from chloric acid, bromic acid, iodic acid, persulfuric acid, potassium iodate, sodium iodate, calcium iodate, and a tetravalent cerium compound.

10. The polishing composition of claim 8, wherein the polishing composition has a pH of 1.0 or more and 2.0 or less.

11. A polishing composition for polishing a tungsten film, comprising:
colloidal silica having an average particle size of 20 nm or more and less than 80 nm which is determined by particle size distribution measurement using a light scattering method, and
an oxidizing agent,
the polishing composition having a passive current value for tungsten of 0 mA or more and 0.5 mA or less, and
the passive current value is defined as the minimum current value observed in a voltage range higher than the voltage at which the current rapidly decreases, based on the surface of the tungsten film being passivated, in a Tafel plot.

12. The polishing composition of claim 11, wherein the oxidizing agent comprises at least one selected from chloric acid, bromic acid, iodic acid, persulfuric acid and their salts, and a tetravalent cerium compound.

13. The polishing composition of claim 12, wherein the polishing composition has a pH of 1.0 or more and 2.0 or less.

14. The polishing composition of claim 12, wherein the oxidizing agent comprises at least one selected from chloric acid, bromic acid, iodic acid, persulfuric acid, potassium iodate, sodium iodate, calcium iodate, and a tetravalent cerium compound.
